(19) United States
(12) Patent Application Publication
(10) Pub. No.: US 2023/0249099 A1
(43) Pub. Date: Aug. 10, 2023

(54) System for Generating Liquid Water from Gaseous Ambient Environment

(71) Applicant: Charles S. Kine, Fountain Valley, CA (US)

(72) Inventor: Charles S. Kine, Fountain Valley, CA (US)

(21) Appl. No.: 18/167,278

(22) Filed: Feb. 10, 2023

Related U.S. Application Data
(60) Provisional application No. 63/308,753, filed on Feb. 10, 2022.

(51) Int. Cl. B01D 5/00

(52) U.S. Cl. CPC B01D 5/0072; B01D 5/009; B01D 5/0051

(57) ABSTRACT

This disclosure is directed to a system for generating liquid water from a gaseous ambient environment containing water vapor. The system includes a mobile trailer and a liquid water generator provided on the mobile trailer. The liquid water generator is configured to generate liquid water by condensing the water vapor from the gaseous ambient environment. An energy source provided on the mobile trailer that is self-contained and is configured to collect and store energy sufficient to power the liquid water generator.

### CROSS-REFERENCE TO RELATED APPLICATIONS

This application claims benefit under 35 U.S.C. § 119(e) of Provisional U.S. Patent Application No. 63/308,753, filed Feb. 10, 2022, the contents of which are incorporated herein by reference in their entirety.

### TECHNICAL FIELD

The present disclosure relates generally to the field of liquid water generation from gaseous ambient environments.

### BACKGROUND

Liquid water is critical for human survival. Though liquid water can be ubiquitous in many locations, potable liquid water can be harder to come by. For example, areas impacted by natural disasters like floods, fires, earthquakes, or tsunamis can rapidly experience dangerous shortages of potable liquid water. Power outages connected to such disasters can compound the problem by disabling the infrastructure relied upon to treat what liquid water is available. Some locations that need liquid water may not have any liquid water readily available. For example, liquid water may not be readily available to combat or prevent forest fires in dry, remote locations.

Accordingly, there exists a need for a system that can generate liquid water from a gaseous ambient environment surrounding the system. To provide liquid water in a wide range of locations there further exists a need for the system to be readily deployable, remotely operable, durable, and for the system to reliably power itself using energy collected from the ambient environment.

### SUMMARY

These needs are met, to a great extent, by a system for generating liquid water from a gaseous ambient environment containing water vapor. The system includes a mobile trailer and a liquid water generator provided on the mobile trailer. The liquid water generator is configured to generate liquid water by condensing the water vapor from the gaseous ambient environment. The system further includes an energy source provided on the mobile trailer that is self-contained and is configured to collect and store energy sufficient to power the liquid water generator.

According to some embodiments, the energy source may include a plurality of panels converting light to electricity, such as solar panels or UV light panels. In other examples, the energy source may be configured to obtain energy from a fuel source, such as gasoline, diesel, biofuel, or hydrogen. A plurality of fuel sources may be converted for energy. In some embodiments, the liquid water generator may further include a condenser to condense the water vapor, and a filter to remove particulates and/or impurities. A filtration system may apply reverse osmosis and/or UV light to treat the generated liquid water.

In some examples, a storage tank may be provided on the mobile trailer, and the storage tank may be configured to receive liquid water from the liquid water generator, e.g., through a plumbing system. The plumbing system may convey water between the liquid water generator and the storage tank. A filtration system and/or a microbe management system may also be applied treat the liquid water and make the water potable. In some examples, a controller may recirculate liquid water in the storage tank through the filtration system.

Accordingly, embodiments may include systems, methods, and computer medium storing instructions, which when executed by a processor, cause a computing system to power a liquid water generator using an energy source, operate the liquid water generator to condense water vapor from the ambient gaseous environment and generate liquid water, pump the liquid water through a filtration system to generate potable water, and collect the liquid water in a storage tank connected to the liquid water generator. In some examples, systems and methods may generate potable water at a rate of up to 1,000 gallons in 24 hours.

As discussed herein, the liquid water generator, the energy source, and the storage tank on a self-contained, movable platform. A controller or other computing system may be configured to monitor a condition the liquid water generator using a sensor and update an operation of the liquid water generator to address the condition. The sensor may be at least one of: a temperature sensor, a humidity sensor, a water level sensor, a flow rate sensor, or a location sensor. The condition may be a temperature, a humidity, a fill level, and/or available power from the energy source.

Various additional objectives, advantages, and features of the disclosure will be appreciated from a review of the following detailed description of the illustrative embodiments taken in conjunction with the accompanying drawings.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 is side schematic view of a system for generating liquid water according to aspects of the disclosure; and

FIG. 2 is a top schematic view of the system of FIG. 1.

FIG. 3 is an illustration of a diagram representing a general purpose computer system in which aspects of the methods and systems disclosed herein or portions thereof may be incorporated.

### DETAILED DESCRIPTION OF ILLUSTRATIVE EMBODIMENTS

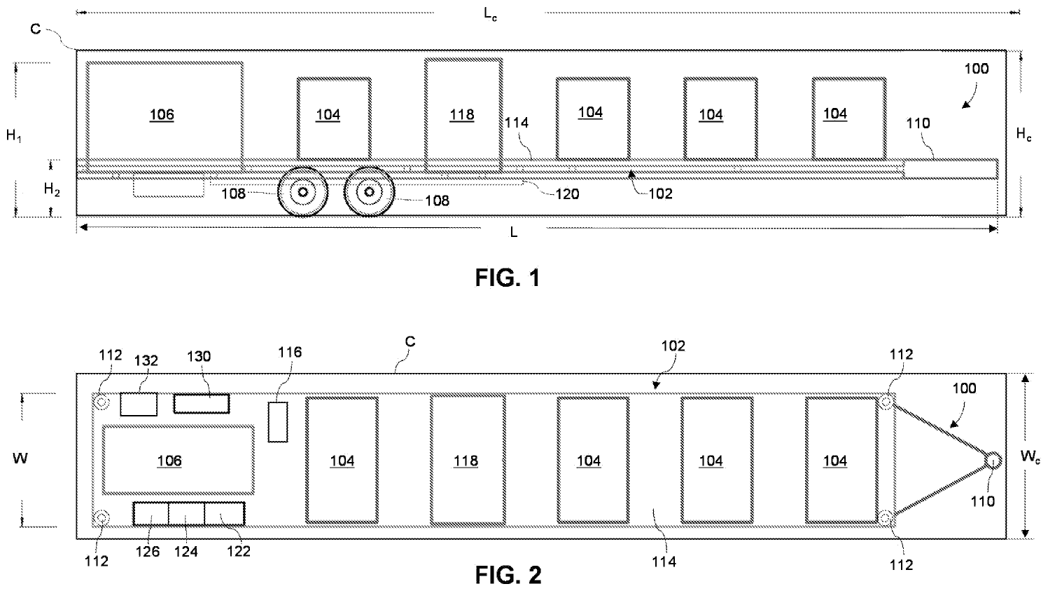

FIGS. 1 and 2 show a system 100 for generating liquid water from a gaseous ambient environment containing water vapor in accordance with aspects of the disclosure. The gaseous ambient environment can include, for example, an atmospheric environment surrounding system 100 that includes air and water vapor. System 100 can include a mobile trailer 102. System 100 can be self-contained on mobile trailer 102, which can allow system 100 to be readily deployed in a wide range of environments in need of liquid water from gaseous ambient environments. System 100 can further include one or more liquid water generators 104 provided on mobile trailer 102. Liquid water generators 104 can generate liquid water by condensing the water vapor from the gaseous ambient environment. System 100 can further include an energy source 106 provided on mobile trailer 102 that is self-contained and is configured to collect and store energy sufficient to power liquid water generators 104. That is, energy source 106 can supply all power necessary to operate liquid water generators 104 and any other powered devices of the system 100 without the need of any local infrastructure or imported fuel source, which can allow system 100 to operate in a wide range of environments.

Aspects of system 100 can be provided on and/or recessed into mobile trailer 102, which can make system 100 highly deployable in a wide range of environments. Mobile trailer 102 can include wheels 108 that movably support mobile trailer 102. In embodiments, wheels 108 can include four 18 ply tires that can be provided on two 10K axles. Mobile trailer 102 can include a hitch 110 that can be connected to a motorized vehicle (not shown) that can tow mobile trailer 102 to desired locations. In embodiments, hitch 110 can include a 3-inch pintle hitch ring. In embodiments, hitch 110 can support a tongue weight of at least 3,500 pounds. In embodiments, hitch 110 can support a tongue weight of at least 6,500 pounds. Additionally or alternatively, mobile trailer 102 can include a tractor that can tow the mobile trailer 102 to desired locations. Mobile trailer 102 can include levelers 112 that can together level and/or stabilize system 100. Levelers 112 can for example be hydraulic stabilizers. Leveling system 100 can help to ensure that liquid water generated by system 100 flows through and/or from system 100 in an intended manner. Levelers 112 can support some or all of the weight of the system 100. Levelers 112 can be provided on each corner of mobile trailer 102. In embodiments, system 100 can weigh at least 16,400 pounds such as for example when system 100 is not storing liquid water. In embodiments, system 100 can weigh at least 26,600 pounds such as for example when system 100 is full of liquid water. Mobile trailer 102 can include a deck 114 that supports various structures of system 100. Deck 114 can include an expanded metal fabric between and around structures of system 100. The various structures of system 100 (tanks 118, electric generator 106, etc.) can be recessed into deck 114 to reduce a maximum height H₁ of system 100. Mobile trailer 112 can include lights 116 that can illuminate various structures of system 100 to, for example, improve usability and/or serviceability of system 100.

System 100 can be dimensioned to fit entirely within a container C, such as a shipping container having standardized dimensions (e.g., a 45-foot-High-Cube container), which can improve the deployability of system 100 by allowing system 100 to be carried to desired locations within container C by ship, plane, helicopter, train, vehicle, etc. For example, system 100 can have a maximum height H₁, width W, and length L that are each smaller than a respective interior height H_{c}, width W_{c}, and length L_{c} of container C such that system 100 fits entirely within container C. In embodiments, the maximum height H₁ can be 98.75 inches+/−5%. In embodiments, the maximum width W can be 88 inches+/−5%. In embodiments, the maximum length L can be 44 inches+/−5%. In embodiments, the hitch 110 can be removable for example by removing bolts that couple hitch 110 to a base of the mobile trailer 102. The maximum length L can exclude the length of the hitch 110, which can for example by 5 feet+/−5%.

Energy source 106 can include one or more panels that convert light from the surrounding environment of system 100 to electricity. Energy source 106 can further include one or more batteries that store the electricity converted by the panels. Energy source 106 can be sized to supply all power needs for system 100. That is, system 100 can be powered solely by energy source 106 without supplemental power from an electric grid. In embodiments, energy source 106 can include panels that can convert UV light to electricity that can be stored in the batteries. Such panels can be more durable and robust than typical solar panels, which can allow the system to be deployed in a wide range of locations. Further, panels that can produce electricity from UV light can be less reliant on direct sunlight, which can allow the system to produce electricity under a variety of conditions including in cloud cover and at night. Additionally or alternatively, energy source 106 can convert energy from a fuel source such as gasoline, diesel, biofuel, hydrogen, etc. to electricity to supply power to system 100.

Liquid water generators 104 can generate liquid water by condensing the water vapor from the gaseous ambient environment. For example, liquid water generators 104 can generate liquid water by condensing water vapor from the air. Each liquid water generator 104 can include a filter that can filter particulates and/or impurities, such as artifacts from smoke or other pollutants, from the air before the water vapor is condensed. This can improve the quality of the liquid water generated by liquid water generators 104.

System 100 can include one or more storage tanks 118 for storing liquid water generated by liquid water generators 104. In embodiments, tanks 118 can have a 1,000-gallon storage capacity, a 10,000-gallon storage capacity, or any other storage capacity compatible with system 100. In embodiments, tanks 118 can include integrated microbe management systems including for example UV lighting to and/or agitators.

System 100 can include plumbing 120 for conveying water between various structures of the system 100. Plumbing 120 can include pipes, valves, fittings, regulators, etc. Plumbing 120 can, for example, convey water generated at liquid water generators 104 to tanks 118. System 100 can include one or more pumps 122 that can pump water throughout plumbing 120. System 100 can include a filter 124, such as for example a reverse osmosis filter, that can filter water generated at liquid water generators 104. System 100 can include a UV light 126 that can sanitize water flowing through plumbing 120. System can include electrical conduits (not shown) electrically connecting various structures of system 100 (e.g., energy source 106, liquid water generators 104, etc.). Plumbing 120 and electrical conduits can be mounted below deck 114.

The system 100 can include a controller 130 that can automatically control aspects of system 100. Controller 130 can include a processor, a non-transitory computer readable medium such as memory, transmitters, receivers, displays, interfaces, and any other computing components. System 100 can include one or more sensors 132 that can detect and communicate data to controller 130, which controller 130 can use to automatically control system 100. Sensors 132 can include, for example, temperature sensors, humidity sensors, level sensors, liquid water flow rate sensors, fill level sensors, GPS tracking among others.

Controller 130 can automatically control operation of the liquid water generators 104 based upon, for example, available power from energy source 106, fill level of tanks 118 as detected by sensors 132, conditions (e.g., humidity, temperature, etc.) of the external gaseous environment as detected by sensors 132. Additionally or alternatively, controller 130 can control pump 122 to recirculate and/or recycle water in tank 118 through plumbing 120, filter 124, and/or UV light 126 to ensure liquid water quality. Additionally or alternatively, controller 130 can control levelers 112 based upon data received from sensors 132

Controller 130 can communicate with external devices, which can for example permit system 100 to be remotely monitored and/or operated. For example, based on data received from sensors 132 and/or from any of the liquid water generators 104, energy source 106, levelers 112, tanks 118, pump 122, filter 124, UV light 126, etc., controller 130 can automatically communicate to an external device remotely monitoring system 100. External device and/or a remote operator can evaluate the data received from controller 130 and take appropriate action including for example shutting down system 100 and/or dispatching a technician to evaluate and/or repair the system 100.

In embodiments, system 100 can create up to 1,000 gallons of potable water averaging between 6-7 pH in 24 hours depending on heat, humidity, ambient air temperature, and dew point for an average cost around $0.23 (USD) per gallon. System 100 can be produced from high quality and/or recycled materials. System 100 can be produced from environmentally friendly materials and run on clean, renewable energy sources such as UV light.

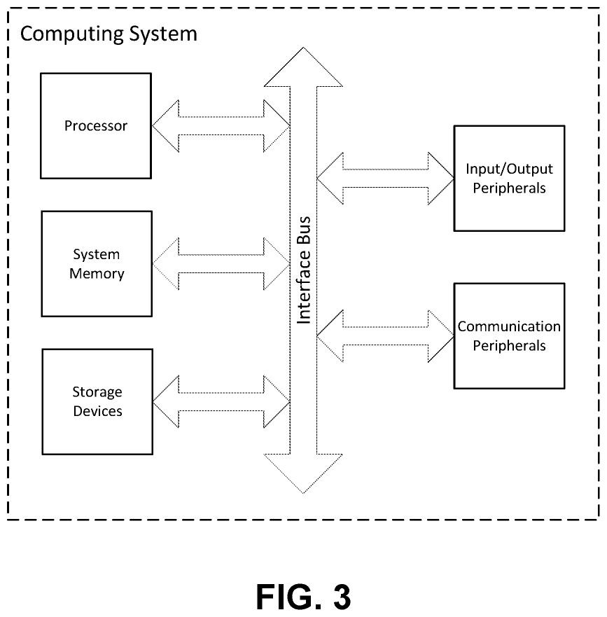

The techniques described above can be implemented on a computing device associated with one or more aspects of the system (e.g., the liquid water generator, the energy source, the storage tank, one or more sensors, etc.), one or more controllers in communication with the system (e.g., controller 130), or a plurality of controllers in communication with the system. Additionally, the techniques may be distributed between the computing device(s) and the controller(s). FIG. 3 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the monitoring and/or operation of the liquid water generator or the energy source, as described above. The computing system components may be present on the mobile trailer/vehicle, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A system for generating liquid water from a gaseous ambient environment containing water vapor, the system comprising:
a mobile trailer;
a liquid water generator provided on the mobile trailer, the liquid water generator is configured to generate liquid water by condensing the water vapor from the ambient gaseous environment; and
an energy source provided on the mobile trailer that is self-contained and is configured to collect and store energy sufficient to power the liquid water generator.

2. The system of claim 1, wherein the energy source comprises a plurality of panels converting light to electricity.

3. The system of claim 2, wherein the light is ultraviolet (UV) light.

4. The system of claim 1, wherein the energy source is configured to obtain energy from a fuel source.

5. The system of claim 4, wherein the fuel source is at least one of gasoline, diesel, biofuel, or hydrogen.

6. The system of claim 1, wherein the liquid water generator comprises a condenser to condense the water vapor, and a filter to remove particulates and/or impurities.

7. The system of claim 1, further comprising a storage tank provided on the mobile trailer and configured to receive liquid water from the liquid water generator.

8. The system of claim 1, further comprising at least one of a filtration system and a microbe management system to treat the liquid water.

9. The system of claim 1, further comprises a plumbing system for conveying water between the liquid water generator and a storage tank.

10. A method for generating liquid water from a gaseous ambient environment containing water vapor, the method comprising:
powering a liquid water generator using an energy source;
condensing water vapor from the ambient gaseous environment to generate liquid water;
pumping the liquid water through a filtration system to generate potable water; and
collecting the liquid water in a storage tank connected to the liquid water generator.

11. The method of claim 10, wherein the energy source converts energy from a plurality of fuel sources to electricity.

12. The method of claim 11, wherein the fuel sources include one or more of: sunlight, ultraviolet light, gasoline, diesel, biofuel, or hydrogen.

13. The method of claim 10, wherein the filtration system applies a reverse osmosis filter and/or ultraviolet (UV) light to treat the generated liquid water.

14. The method of claim 10, further comprising generating the potable water at a rate of up to 1,000 gallons in 24 hours.

15. The method of claim 10, further comprising providing the liquid water generator, the energy source, and the storage tank on a self-contained, movable platform.

16. A non-transitory, computer-readable medium storing instructions, which when executed by a processor, cause a computing system to at least:
power a liquid water generator using an energy source;
operate the liquid water generator to condense water vapor from the ambient gaseous environment and generate liquid water;
pump the liquid water through a filtration system to generate potable water; and
collect the liquid water in a storage tank connected to the liquid water generator.

17. The non-transitory, computer-readable medium of claim 15, wherein the instructions, when executed by the processor, further cause the computing system to:
monitor a condition the liquid water generator using a sensor; and
update an operation of the liquid water generator to address the condition.

18. The non-transitory, computer-readable medium of claim 17, wherein the sensor is at least one of: a temperature sensor, a humidity sensor, a water level sensor, a flow rate sensor, or a location sensor.

19. The non-transitory, computer-readable medium of claim 17, wherein the condition is at least one of: a temperature, a humidity, a fill level, or available power from the energy source.

20. The non-transitory, computer-readable medium of claim 15, wherein the instructions, when executed by the processor, further cause the computing system to: recirculate liquid water in the storage tank through the filtration system.
